(19) United States
(12) Patent Application Publication
(10) Pub. No.: US 2016/0254959 A1
(43) Pub. Date: Sep. 1, 2016

(54) PROVISIONING A NETWORK FOR NETWORK TRAFFIC DURING A SESSION

(71) Applicant: HEWLETT PACKARD ENTERPRISE DEVELOPMENT LP, Houston, TX (US)

(72) Inventor: Manfred . R. Arndt, Roseville, CA (US)

(21) Appl. No.: 15/028,469

(22) PCT Filed: Oct. 11, 2013
(86) PCT No.: PCT/US2013/064671

§ 371 Date: Apr. 11, 2016

(51) Int. Cl. H04L 12/24; H04L 29/06

(52) U.S. Cl. CPC H04L 41/0896; H04L 41/0816; H04L 65/80; H04L 65/1069; H04L 65/1083

(57) ABSTRACT

The present specification, therefore describes a network system comprising a software-defined network (SDN) controller and an application program interface (API) communicatively coupled to an application and the SDN controller, in which real-time adjustments to sessions are made by the SDN controller by dynamically reacting to changes in the network and a number of end-point devices on the network. A method of provisioning a network for network traffic during a session, comprising communicatively coupling a number of end-point devices using a user application with and SDN controller and initiating real-time adjustments to the session by dynamically reacting to changes in the network and end-point device quality metrics.

### BACKGROUND

Unified Communications (UC) is the integration of a number of communication services over a network connection such as an internet, an intranet, or the Internet. These communication services may comprise instant messaging, telephony, audio conferencing, video conferencing, emailing, and desktop sharing, among others. Each of these services implements a number of applications in order to send data through the network. Additionally, each service uses a portion of the network bandwidth to deliver the information over the network.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a network according to one example of the principles described herein.

FIG. 2 is a block diagram showing a software-defined network system according to one example of the principles described herein.

FIG. 3 is a flowchart showing a method of provisioning a network for network traffic according to one example of principles described herein.

FIG. 4 is a block diagram showing a software-defined network system according to another example of the principles described herein.

FIG. 5 is a flowchart showing a method of provisioning a network for network traffic during a call according to one example of principles described herein.

Throughout the drawings, identical reference numbers designate similar, but not necessarily identical, elements.

### DETAILED DESCRIPTION

As described above, each communication service may be implemented over a network connection having a physical bandwidth limitation. This results in all data being sent from a network having to share the available bandwidth.

A network may be a combination of hardware and software that includes a number of switches, routers or wireless access points, and instructions processed by the switches, routers and wireless access points to define the forwarding behavior of data packets. Further, as used in the present specification and in the appended claims, the term “switch” or “router” is meant to be understood broadly as any connection point within a network and can apply equally to a wide area network (WAN) router, wireless access point, firewall, security device, or any other networking device.

If all the data sent out from the network was non-latency-sensitive data, a switch may simply buffer the data packets as they are received and then send those data packets out from the network as bandwidth is available according to a “best effort” policy. To the users involved with this process, the latency or packet loss, due to heavy network traffic from the buffering of a number of packets or from packet loss due to all switch buffers in use while receiving or sending out packets may even be unnoticeable in this situation. However, when latency-sensitive types of data services such as interactive voice or video conferencing are being used over the network, heavy traffic or congestion in a network may cause audio and/or video quality degradation which is noticeable to a user. Heavy traffic comprising non-latency-sensitive packets and latency-sensitive packets may result in a bottleneck forming on a network connection and creating a reduction in the quality of experience (QoE) for the user.

As traffic is forwarded across the network, each data packet sent comprises a packet header. In an attempt to overcome network traffic bottlenecks described above for latency-sensitive packets, some network administrators have implemented a brute force method to improve the QoE. The brute force method leverages the user datagram protocol (UDP), or transmission control protocol (TCP) packet headers of each data packet transmitted. A source and destination port number may be designated within these headers by the individual applications and, via an application data center, a certain range of port numbers may be assigned to the header of a specific type of network traffic. Alternatively, a source IP address or destination IP address within the header may be used to identify the type of network traffic, or combinations thereof. In some examples, the type of network traffic may be application specific while in other examples, the type of network traffic may be generally defined such that voice data packets, video data packets, and other types of data packets may have their headers designate a type of data by assigning them a specific range of ports.

As each packet enters the network, an access switch may determine the port number range or IP addresses using deep packet inspection (DPI). The discovered port number or IP addresses may be compared with an access control list (ACL) at the access switch to determine what type of data is in the payload and enforce the policies associated with the ACL. Consequently, some latency-sensitive data may be given preferential treatment over other non-latency-sensitive data. The packets may be marked by rewriting the packet priority at the edge of the client network or some other network boundary or be implemented at each switch in the network. In one example, the layer 2 header priority may be modified to reflect the queuing priority. In another example, the layer 3 differentiated service code point (DSCP) may be modified. The brute force method, however, requires that static policies match application server settings or some other static identifiable attribute within the packet header. Additionally, the brute force method may not react appropriately to topology changes, radio frequency (RF) interference, varying link capacity, congestion, among other dynamic changes in the network.

Another solution may be to have each end-point computing device appropriately mark the packet priority itself, in its header, before sending the packet out. This, however, is not a desirable option for a user and some end-point devices such as smartphones are consumer oriented and may not support this capability to change the quality of service (QoS) settings. Still further, if a user is responsible for manually updating the QoS on his or her device for a specific application, all other device users may do the same and a situation may begin to exist where all applications on all end-point devices have the maximum QoS settings, thereby creating the same problem as before with each end-point device and applications being equally treated. In order to prevent this from happening, a network administrator may configure the access switch to ignore the QoS settings assigned by the end-point in the packet header. A trust boundary may be created where the network administrator by default modifies the packet header priority to “best effort” and only increase the priority for selected types of latency-sensitive data packets.

The present specification, therefore describes a network system comprising a software-defined network (SDN) controller and an application program interface (API) communicatively coupled to an application and the SDN controller, in which real-time adjustments to sessions are made by the SDN controller by dynamically reacting to changes in the network and runtime adjustments associated with a number of end-point devices on the network.

The present specification further describes a method of provisioning a network for network traffic during a session, comprising communicatively coupling a number of end-point devices using a user application with an SDN controller and making real-time adjustments to the sessions by dynamically reacting to changes in the network and end-point device quality metrics. The method uses an application program interface (API) that describes application specific information associated with a number of end-point devices using an application to initiate the real-time adjustments.

Still further, the present specification describes a computer program product for provisioning a network for network traffic during sessions, the computer program product comprising a computer readable storage medium comprising computer usable program code embodied therewith, the computer usable program code comprising computer usable program code to, when executed by a processor, communicatively couple a number of end-point devices using a application with an SDN controller and computer usable program code to, when executed by a processor, initiate real-time adjustments to the sessions by dynamically reacting to changes in the network and end-point devices.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “session” is meant to be understood broadly as any runtime instance of a voice call, video conferencing application, desktop sharing, interactive gaming, or any other application that would benefit from low latency traffic, preferential QoS policy, or other specific network policy treatment. In some examples, the sessions may be the transmission of data packets on a network comprising voice, video, data, or combinations thereof.

Additionally, in the present specification and in the appended claims, the term “best effort” is meant to be understood broadly as any type of default QoS service all traffic on a network receives by default and which is subjected to all remaining bandwidth available on a network connection and/or remaining buffer resources available within switches along the path, after all QoS policies have been applied to the preferential traffic on a network connection.

Further, in the present specification and in the appended claims, the term “node” is meant to be understood broadly as any connection point within a network. In some examples, a node may be a network switch that communicatively links network segments or network devices within the network. In other examples, a node may be a router that forwards data packets between networks. In still other example, a node may be a firewall or other security device within the network. In yet another example, a node may be a wireless access point that communicatively links network devices wirelessly with the network.

Even further, as used in the present specification and in the appended claims, the term “a number of” or similar language is meant to be understood broadly as any positive number comprising 1 to infinity; zero not being a number, but the absence of a number.

Additionally, in the present specification and in the appended claims the term “network” is meant to be understood broadly as any combination of hardware and software that includes a number of switches, routers or wireless access points, and instructions processed by the switches, routers and wireless access points to define the forwarding behavior of data packets.

Further, as used in the present specification and in the appended claims, the term “switch” or “router” is meant to be understood broadly as any connection point within a network and can apply equally to a WAN router, wireless access point, firewall, security device, or any other networking device.

Still further, as used in the present specification and in the appended claims, the term “real-time” is meant to be understood broadly as the processing of information that returns a result so rapidly that the interaction appears to be instantaneous. In one example, the system may provide real-time data to an application data center and a SDN controller in order to make adjustments to sessions running on a network and dynamically reacting to changes in the network and a number of end-point devices on the network.

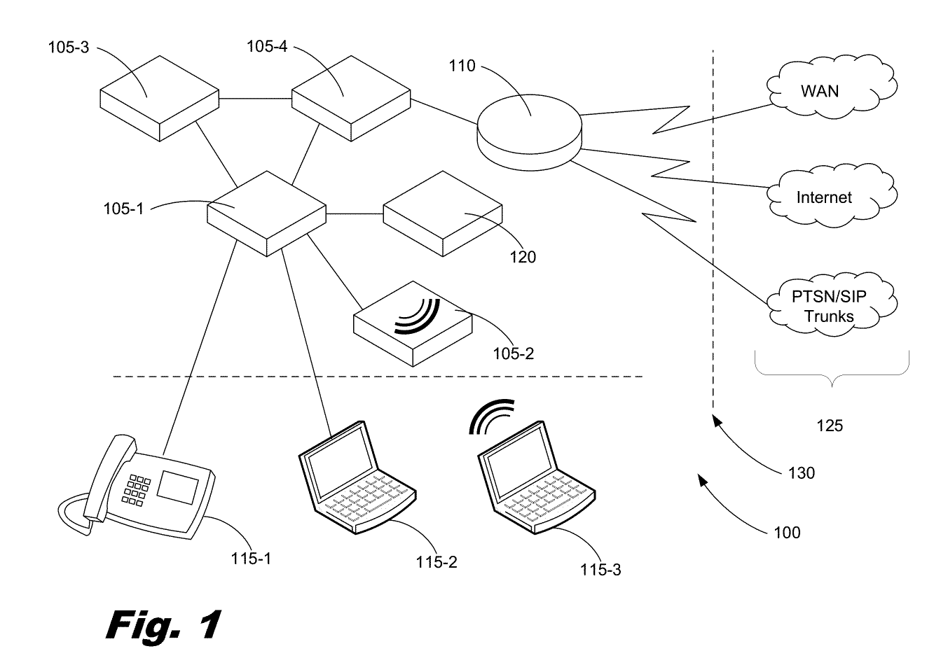

FIG. 1 is a block diagram of a network (100) according to one example of the principles described herein. The network (100) may comprise a number of switches (105-1, 105-2, 105-3, 105-4), a router (110), an SDN controller (120), and a number of end-points (115-1, 115-2, 115-3) communicatively coupled to the network (100). The network (100) may be a local area network (LAN), a wide area network (WAN), a personal area network (PAN), a campus area network (CAN), a metropolitan area network (MAN), or combinations thereof. The network may further comprise any number of routers (110), switches (105-1, 105-2, 105-3, 105-4), end-point devices (115-1, 115-2, 115-3) each communicatively coupled to each other via either a wired connection or wireless connection. The example shown in FIG. 1 is merely meant to be presented as an example and is not meant to be limiting on the size or type of network (100) on which the present system and method may operate on.

Each switch (105-1, 105-2, 105-3, 105-4) may comprise any type of networking device that links network segments or network devices together. Additionally, each switch may comprise computer readable program code embodied on a computer readable media that receives, processes, and forwards or routes data to and/or from devices within the network (100). In one example, each switch (105-1, 105-2, 105-3, 105-4) may be controlled by a software-defined network (SDN) controller (120) in a software-defined network (SDN). Consequently, the decision as to where traffic is sent may not be determined solely by the individual switches (105-1, 105-2, 105-3, 105-4), but instead may be centralized in a single SDN controller (120). Again, although FIG. 1 shows a single SDN controller (120), this is merely meant as an example and the present application contemplates the use of a number of SDN controllers (120) that may control a number of switches (105-1, 105-2, 105-3, 105-4) with another SDN controller (120) controlling all of the SDN controllers (120) below it. In one example, the policy decisions made by each switch (105-1, 105-2, 105-3, 105-4) is controlled by the SDN controller (120) using, for example, OpenFlow or some other communications protocol that gives access to control the forwarding plane of any individual network switch (105-1, 105-2, 105-3, 105-4) or router (110) over the network (100). This allows a network administrator to provide a single point at which forwarding behavior and QoS policies may be implemented and propagated throughout the network (100) irrespective of the type or policy maker used by the device. OpenFlow is a protocol specification managed by the Open Networking Foundation (ONF) which is trade organization consortium of a number of member parties dedicated to promoting and adopting SDNs.

The router (110) may be any device that forwards data packets between networks. In the example shown in FIG. 1, the network (100) comprises a single router (110). However, the present application contemplates that any number of routers (110) may be used within the network (100). FIG. 1 shows, however, a situation where the router (110) provides access to a number of service providers (125) outside of the network (100). In this example, the router (110) creates a bottleneck where all data coming into and going out of the network (110) must pass through the router. In some examples, the router (110) connects the network (100) to the services (125) with a connection having a limited amount of bandwidth. Because of the cost of operating, for example, an internet service connection on the network (100), a business entity may find it difficult to increase the bandwidth capacity of this connection. As such, the connection between the router (110) and the services (125) may create a bottleneck during increased traffic scenarios. The connection between the router (110) and the service providers (125) may be conceptually realized as an enterprise edge (130). The enterprise edge (130) may be the demarcation point where the network (100) operated by one entity ends and services provided to the network (100) by another entity (125) are provided.

The number of end-points (115-1, 115-2, 115-3) may comprise any node of communication from which an individual user of the network (100) may gain access to the network and applications and services provided thereon. In one example, the end-point may be a computing device comprising a processor and a data storage device. In this example, the computing device may be capable of communicating with the network (110) in order to send emails, send data, engage in video or audio conferences, or combinations thereof. The end-points (115-1, 115-2, 115-3) may communicate with the network (100) either wirelessly or wired.

In another example, the end-point may be a telephone capable of communicating with the network (100) in order to, for example, deliver interactive voice communication and real-time multimedia calls over internet protocol (IP) such as voice over IP (VoIP). As described above, the network (100) may give preferential priority to each of these different types of communication by defining them as either a latency-sensitive data transfer or a non-latency-sensitive data transfer. Consequently, the SDN controller (120) may properly define the forwarding or routing behavior of the data packets sent by specific application sessions on the end-points (115-1, 115-2, 115-3) in an efficient manner without degradation of the user experience in latency-sensitive communications.

The services (125) may comprise a connection to a wide area network (WAN), a connection to the Internet, a connection to a public switched telephone network (PSTN) trunk, or a wireless cellular network, among others, or combinations thereof. It is these services from which the users of the end-points (115-1, 115-2, 115-3) may wish to access through the router (110) and which may cause the bottleneck as described above.

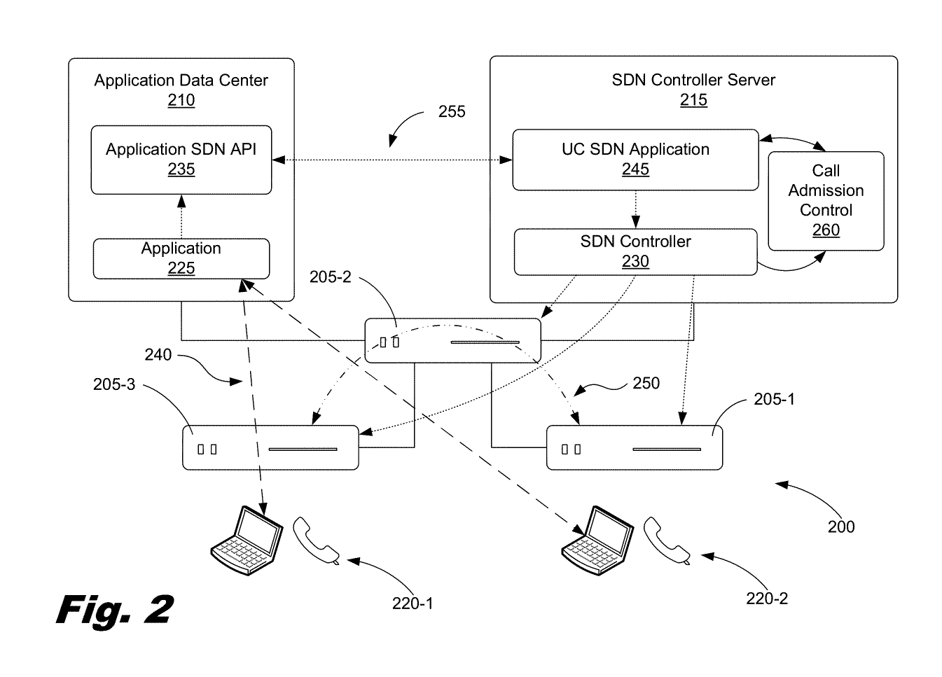

FIG. 2 is a block diagram showing a software-defined network system (200) according to one example of the principles described herein. FIG. 2 shows a similar network (FIG. 1, 100) as that shown in FIG. 1 with a number of switches (205-1, 205-2, 205-3) communicatively coupled to a number of end-points (220-1, 220-2). The network of the system (200) may be communicatively coupled to an application data center (210) and SDN controller server(s) (215). The application data center (210) may comprise a number of servers which facilitate a service. The service may be implemented using an application (225). The application may provide a third party service accessed by the user to, for example, provide real-time communication services under a unified communications scenario. Virtual desktops, thin clients, and other devices that would benefit from low latency traffic and good user experience would benefit from the use of the application (225). In one example, the application data center (210) could be running an application (225) such as Lync® and therefore provide those services to the user through the SDN controller (230). Lync® is a unified communications client that provides instant messaging services, voice and video conferencing using client software created by the Microsoft Corporation. In the present specification, Lync® is merely one example and a number of other services may be provided to the users of end-points (FIG. 1, 115-1, 115-2, 115-3, 220-1, 220-2) using a number of different applications (225) operating in a number of application data centers (210). Still further, each of the application data centers (210) may be communicatively coupled to a number of SDN controller server(s) (215), each using a specific API such as the SDN application API (235) shown in FIG. 2. In one example, the number of SDN controllers (230) is one. In another example a plurality of SDN controllers (230) may exist and each may be communicatively coupled to the application data centers (210) based on geographic location of the SDN controller server(s) (215). In yet another example, the SDN controller (230) may control a number of subordinate SDN controllers based on geographic location of those subordinate controllers. In this example, the QoS policies and operation of the present systems and methods may be sent down to the subordinate controllers.

The communication between the application data center (210) and the SDN controller server(s) (215) allows for a single point of trust to be established in the network. Instead of relying on gaining trust from each end-point device (220-1, 220-2), trust need only be established between the application data center (210) with its application (225) and the SDN controller (230). In a network with thousands and sometimes hundreds of thousands of devices connected within the network, attempting to establish trust between each of the end-point devices (220-1, 220-2) would be difficult if not impossible to achieve. In this case, a single point of trust is established between the application data center (210) and a single version of an application SDN application protocol interface (API) (235) may be used to communicate with the SDN controller server(s) (215).

In FIG. 2, when a first end-point device (220-1) attempts to communicate with a second end-point device (220-2), a signal (240) may be sent to the application data center (210) and received by the application (225). The application (225) may decrypt the network traffic and know that the first end-point device (220-1) is attempting to communicate with the second end-point device (220-2). Additionally, the application (225) may further receive data describing what type of application is attempting to be run, the individual IP addresses associated with the end-point devices (220-1, 220-2), as well as how much bandwidth they require to run the application. It may therefore, receive logical information as described above, but may not know the physical network topology information regarding the first and second end-point devices (220-1, 220-2), such as the physical location of the devices within the network. The SDN controller (230), however, knows the physical topology of the network, but does not know what application type or network bandwidth requirements the first and second end-point devices (220-1, 220-2) are attempting to implement. After the signal (240) has been received the application (225) may, through the application SDN API (235), send the known data to the SDN controller (230). For example, this information may be received by a unified communication SDN application (245) which then forwards it onto the SDN controller (230). The information is used by the SDN controller (230) to determine what type of application is attempting to be run and program the individual switches (205-1, 205-2, 205-3) to assign a forwarding behavior, including level of QoS priority to the switches communicatively coupling the first and second end-point devices (220-1, 220-2). Since the network capacity may be shared by many users and different applications, the controller may choose to only allow an application to use a portion of the available capacity, based on administrative policy or calculated based on historical trends. Rather than allowing an application to attempt grabbing all the available bandwidth. After this is completed, the traffic flow (250) between the first and second end-point devices (220-1, 220-2) will be properly prioritized creating an improved peer-to-peer communication session between the two devices.

The system described in FIG. 1, therefore, allows a single SDN controller (230) to propagate forwarding behaviors and number of QoS polices to a number of switches (105-1, 105-2, 105-3, 105-4, 205-1, 205-2, 205-3) in the network (100) of the system (200). In addition to this, the system may engage in call admission control. Call admission control is a method that can be implemented by the SDN controller (230) that describes which sessions to reject or assign to a lower priority than other sessions. The system may also set rate limits to specific applications sessions to protect the network and ensure that certain applications do not exceed a certain level of bandwidth. Still further, the system may allow for load balancing and policy-based routing (PBR) such that traffic may be directed across the network based on certain policies. These policies may look at, for example, the cost of forwarding the data packets via a certain connection versus another connection; the hardware used to forward the data packet over either connection; and the time sensitive nature of the payloads associated with the data packets. Consequently, in some examples, the SDN controller (FIG. 2, 230) may generate policies based on the application data received by the application (225) via the application SDN API (FIG. 2, 235) to direct data packets to be routed by one router or over one network connection instead of another based on the cost of routing that data or level of service available over that specific router connection.

The application SDN API (235) may further be a bidirectional API. In this example, the system (200) may receive data from the application (225) on the application data center (210) via the application SDN API (235) as described above. This data comprises information regarding the end-point devices (220-1, 220-2) which are attempting to communicate, the IP addresses of the end-point devices (220-1, 220-2), and what type of applications are attempting to be run in order to allow the end-point devices (220-1, 220-2) to communicate. The application (225) and application data center (210) are, however, not aware as to the amount of traffic on the network within the system (200). The SDN controller (230) is aware of the traffic flow and may provide this information to the application (225) via the bidirectional API data link (255).

In some examples, the SDN controller (230) may assign a specific differentiated services code point (DSCP) within a number of code points to a specific application or type of applications. This allows the SDN controller (230) to reserve a portion of the bandwidth to a specific type or specific application that is transmitting latency-sensitive data. The SDN controller (230), therefore, implements a call admission control and diagnostics (260) function that provides feedback to the application SDN API (235) and the application (225) regarding availability of bandwidth and/or level of service capabilities of the network. The call admission control and diagnostics (260) by providing feedback via the application SDN API (235) may mitigate poor user experience and protect current sessions from degradation resulting from the additional bandwidth of another session or other dynamic changes in the network. Additionally, the call admission control and diagnostics (260) and/or the feedback via the application SDN API (235) may reduce or eliminate the amount of diagnostics that need to be manually performed on the network by having the SDN controller (230) providing feedback via the application SDN API (235) to dynamically adjust application session characteristics whenever a poor user QoE is experienced due to high traffic or other dynamic changes in the network.

The call admission controller and diagnostics (260) directs the UC SDN application (245) to return information to the application (225) regarding availability of bandwidth and/or level of service capabilities of the network. In one example, one or more users may have initiated a video conference with other users of the network. The UC SDN application (245) may then request information from the call admission control and diagnostics (260) as to the currently available bandwidth or level of service capabilities of the network. If insufficient bandwidth or level of service is available for all the current video conference sessions, the call admission control and diagnostics (260) may notify the application via the application SDN API (235) to dynamically select a different codec type, adjust the compression function, or Forward Error Correction (FEC) algorithm, or combinations thereof for some or all of the videoconference sessions in process. Alternatively, the call admission control and diagnostics (260) may dynamically adjust the forwarding behavior, rate-limiting, load balancing, policy based routing (PBR), least-cost routing, security, or wireless roaming policy of a number of switches (105-1, 105-2, 105-3, 105-4, 205-1, 205-2, 205-3) in the network (100) of the system (200). However, where insufficient bandwidth is available for a given traffic class of service, the call admission control and diagnostics (260) may direct the UC SDN application (245) to direct the application (235) to terminate some of the sessions if insufficient network resources are available. The user of end-point device (220-1) may see on a user interface associated with the first end-point device (220-1) the notification. This prevents all users of the application running with active sessions for a specific class of service from having a poor QoE while transmitting their respective latency-sensitive data across the network, due to topology changes, or other dynamic changes in the network.

In one example, a codec is used for encoding or decoding data packets. Different types of codecs have different types of lossy properties. If a type of codec is used during a session experiencing a certain level of packet loss, a user may experience a session with poor quality. By instructing the application (220) to select a different codec type, the user may experience a session with excellent quality.

In another example, a compression function is used to compress data packets. If a compression function is used during a session with low compression quality, a user may experience a session with poor quality. By instructing the application (220) to adjust the quality of a compression function to a higher compression quality, the user may experience a session with excellent quality.

In one example, forward error correction (FEC) is used for correcting errors in the transmission of data packets over unreliable networks. In one example, by instructing the application (220) to adjust the FEC, the data packets may be encoded in a redundant manner such that a user may experience a session with excellent quality.

In another example, the call admission control and diagnostics (260) may allow an additional latency-sensitive service onto the network, but will direct the application to dynamically adjust all, or some of the current latency-sensitive services to run at a higher compression rate in order to reduce the bandwidth usage. In some examples, adjusting to a higher compression of the latency-sensitive data may be unnoticeable to the other users of the system (200) and will provide higher scalability of concurrent sessions that can be supported, for example during peak usage hours, occasional periods of unexpected high demand for a given service, or during periods of degraded level of service capability available on the network. This may allow the system (200) to provide both a higher quality of experience when a low number of concurrent sessions are active, while also allowing for higher scalability of services in a dynamic manner due to some or all of the services being more compressed in order to support additional users or additional services on the network, or combinations thereof.

In yet another example, the call admission control and diagnostics (260) may inform users to determine whether the session can be adjusted to a higher compression rate, with reduced functionality, or to terminate the session. In this example, the call admission controller and diagnostics (260) may provide the application (235) with information as to the current available bandwidth and the application may return the above mentioned options to the user via an interface selection. In this example, the user may elect to switch to a videoconference call with a higher compression rate, or elect to switch to an audio call without any video. This also allows for all other users of the system (200) engaging in similar latency-sensitive data transfers to be minimally affected by network congestion, or other dynamic changes in the network. The policies directing the call admission control and diagnostics (260) to provide the application with the above mentioned options to the user of the end-point (220-1) devices may be dictated by the administrative policies configured on the SDN controller.

In still another example, the call admission control and diagnostics (260) may direct the user application (225) to change the compression function or adjust the forward error correction (FEC) or combinations thereof of current application sessions in order to mitigate packet loss and improve the user QoE resulting from network congestion or other dynamic changes in the network. In this example, the user application may direct the end-point device (220-1, 220-2) to encode their data packets in a redundant way by using, for example, an error-correcting code (ECC). The redundant data allows the application (225) to detect a limited number of errors that may occur anywhere in the data packet and correct these errors without retransmission.

In some examples, the SDN controller may partition out the available bandwidth such that different types or classes of data packets have a predefined amount of bandwidth provisioned to them. For example, if the total available bandwidth was 10 megabytes, ⅓^{rd} of that may be reserved for video conferencing associated data packets, ⅓^{rd} may be reserved for voice communications, and the rest may be available for all other types of data packets being transmitted. The SDN controller (230) with the call admission control and diagnostics (260) may then be able to communicate to the application in the data center (210) such that the application may be limited, if necessary, to the QoS policies dictated by the SDN controller and the currently available bandwidth for that type or class of data packet transmission.

The system (200) shown in FIG. 2 is merely an example of the physical layout of the system (200) and the present application contemplates other physical layouts. In one example, the SDN controller (230) may be only enabled at certain access switches (205-1, 205-3) instead of the entire number of switches within a network. In this example, the access switches (205-1, 205-3) may be the only switches that the SDN controller (230) applies the policies to in order to provide more efficiency.

In another example, the SDN controller (230) may only be enabled for a certain number or kind of applications. In this example, an administrator of the network may have the SDN controller (230) only apply its policies when certain applications (225) are run. In this example, all other data packets originating from all other types of applications would be transmitted using either statically provisioned policies or as a “best effort” regime such that all other applications would be given whatever bandwidth is available after the SDN controller (230) controlled applications have been partitioned the appropriate amount of bandwidth.

Additionally, although FIG. 2 shows a number of switches in which the SDN controller (230) applies policies to, the present application further contemplates a system in which the SDN controller (230) manages other types of nodes within the network. In one example, a router may also be managed by the SDN controller (230) such that the router may route data packets based on the policies of the SDN controller (230). In this case, the SDN controller (230) may allow routing of data packets on a per-session basis such that when a session is made, a port may be opened for that specific source and destination pair. This may prevent others from receiving access to the network through previously unsecured ports. The knowledge about the application information sent to the SDN controller (230) from the application (225) may be used to provide better secure firewalls in a dynamic manner such that certain port numbers are not left open all the time and instead are only opened for the duration of a session and on a session-by-session basis.

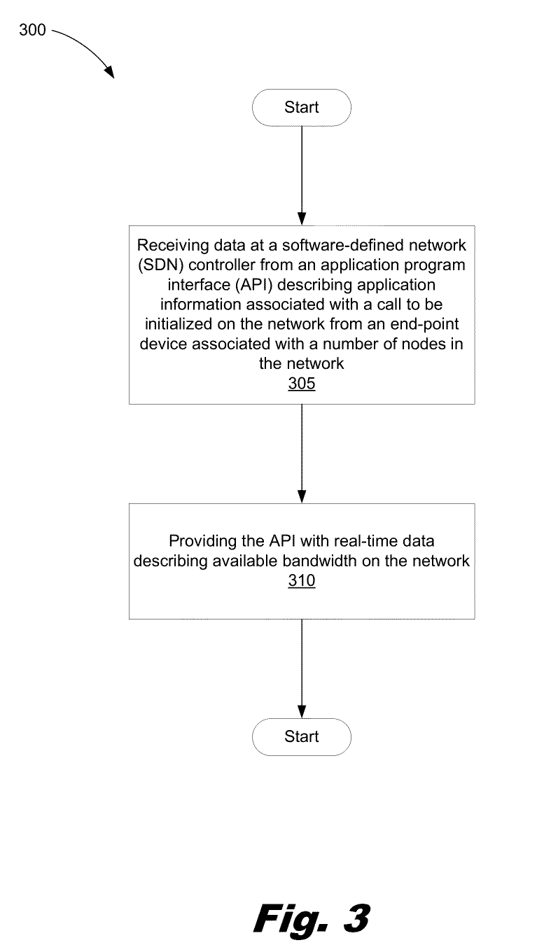

FIG. 3 is a flowchart showing a method (300) of provisioning a network for network traffic according to one example of principles described herein. The method (300) may begin with the SDN controller (FIG. 2, 230) receiving (305) data from an application program interface (API) describing application information associated with current sessions running on the network from end-point devices associated with a number of nodes in the network. As described above, the data received by the SDN controller (FIG. 2, 230) may comprise information about the end-point devices (FIG. 2, 220-1, 220-2) to be communicated and the application by which they are communicating with. The application (FIG. 2, 225) used to communicate with may be any type of application and an associated application SDN API (FIG. 2, 235) may be used to communicate this data to the SDN controller (FIG. 2, 230).

The method (300) may continue with the SDN controller (FIG. 2, 230) providing (310) the application SDN API (FIG. 2, 235) with real-time data describing available bandwidth of the network. In one example, if insufficient network bandwidth is currently available, the API may forward to the application (FIG. 2, 225) a message from the SDN controller (FIG. 2, 230) indicating that a degraded level of services is currently available. If there is some, but only a limited amount of bandwidth, the API may forward to the application (FIG. 2, 225) a message from the SDN controller (FIG. 2, 230) indicating that available services are currently low and that, for example, in the case of video conferencing, the compression rate may need to be increased in order to allow the current session to continue providing a good user QoE. The users of the end-point devices (FIG. 2, 220-1, 220-2) may then choose to continue with the video conference at the lower compression rate, select an audio only conference, or wait till a later time when the network traffic is lower and then resume with a higher quality session at a lower compression rate.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, a processor or other programmable data processing apparatus, implement the functions or acts specified in the flowchart and/or block diagram block or blocks. In one example, the computer usable program code may be embodied within a computer readable storage medium; the computer readable storage medium being part of the computer program product.

The computer readable storage medium may comprise computer usable program code to, when executed by a processor, receive data at a software-defined network (SDN) controller from an application program interface (API) describing application information associated with sessions currently running on the network from end-point devices associated with a number of nodes in the network. The computer readable storage medium may further comprise computer usable program code to, when executed by a processor, provide the API with real-time data describing available bandwidth and/or level of service available on the network.

The specification and figures describe a network system and method of provisioning a network for network traffic. The system and method alleviate the need for devices on the network to perform packet inspection for each data packet being transferred on the network. This is because the API associated with the application data center may transmit specific data describing the specific session characteristics of the application being accessed by the end-point device. Still further, the SDN controller (230) provides a user friendly and more scalable environment by which policies need not be manually configured by a network administrator on every access switch or node in the network in order to derive what the session communication needs are. The application information can be used for a number of network policy purposes including, but not limited to, quality of service provisioning, call admission control, rate-limiting, load balancing, policy based routing (PBR), least-cost routing, security, firewall traversal, and wireless roaming policy, or combinations thereof. The system further provides for a bi-directional flow of information between the SDN controller (230) and the application (225) such that the application (225) does not assume as to what the network congestion conditions or performance characteristics of the network are and any corrective action can be coordinated between the application and the network. The system and method also allows for the application to use networking information or feedback to dynamically adjust the application session parameters to improve the user experience and/or more effectively utilize networking resources.

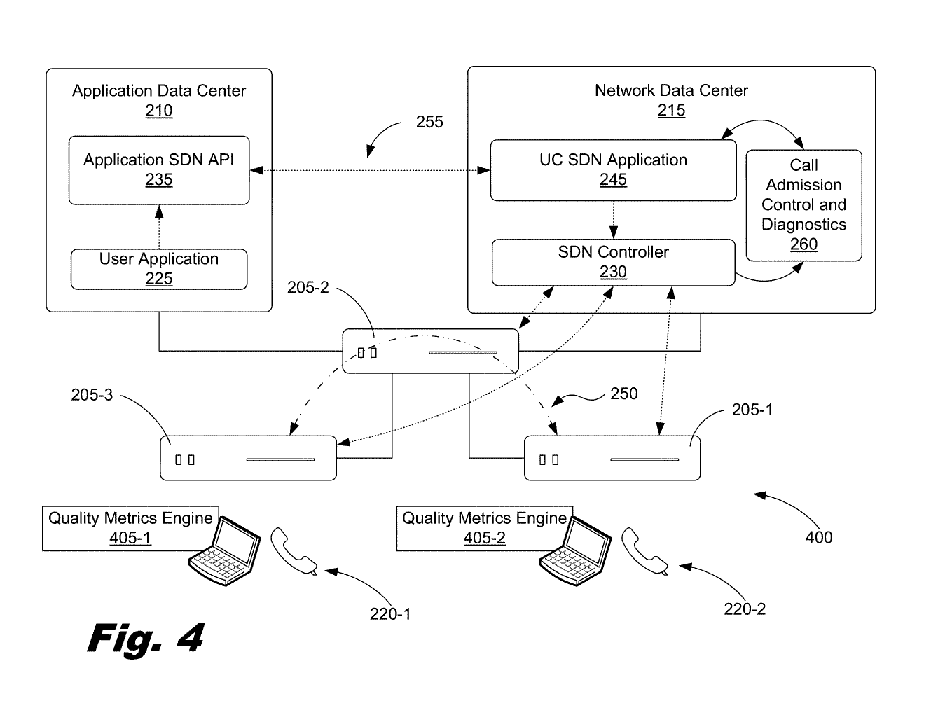

Turning now to FIG. 4, a block diagram is shown showing a software-defined network system (400) according to another example of the principles described herein. In this example, the end-point devices (220-1, 220-2) have been connected and are engaged in a latency-sensitive call as shown by the active session traffic flow (250) between the devices and their respective switches (205-1, 205-3). As videoconferencing and teleconferencing technologies develop, the use and bandwidth requirements of these types of latency-sensitive communication applications may also increase thereby creating higher traffic flow in the network. However, during a session, the availability of network bandwidth or performance characteristics may not remain static. This may be the result of some network event such as a failure of a WAN, LAN or wireless connection or change in radio frequency (RF) interference, varying link capacity, congestion, among other dynamic changes in the network. This may limit the available bandwidth for a portion or the entire network. Because the end-point devices (220-1, 220-2) are currently engaged in a latency-sensitive session, this may result in the session quality being degraded or the session being dropped all together, if no adjustments are made to the application sessions currently in process.

The SDN controller (230), however, may accommodate for these dynamic network issues by using its global network knowledge and control to react to the changing network conditions in order to provide an improved level of QoE and better user satisfaction. The SDN controller (230) may do this by taking advantage of discovered information received by the application (225) via the SDN application API (235).

In one example, the SDN controller (230) may use the data it received from the application (225) in order to better accommodate for the currently engaged sessions by instructing for real-time adjustments to the application. This data from the application may comprise information regarding the session-type, amount of bandwidth required, end-point device (220-1, 220-2) policies, and n-tuple values of the currently active application sessions associated with end-point devices (220-1, 220-2), among others. For example, because the SDN controller (230) may be aware of the amount of historical bandwidth previously required by the end-point devices (220-1, 220-2) and in order to accommodate the currently active sessions, the SDN controller (230), after a network event has occurred, may adjust the network policies or bandwidth reservations to minimize the degradation of the QoE of latency-sensitive calls between the end-point devices (220-1, 220-2).

Additionally, because the SDN controller (230) is aware of certain policies, session characteristics and network resources associated with each end-point device (220-1, 220-2), the SDN controller (230) may take dynamic actions sufficient to adjust policies, session characteristics or network resources if the enforcement of current policies would be detrimental to the QoE of other currently active sessions. For example, the SDN controller (230) may know that a specific end-point device (220-1, 220-2) is consuming a disproportionate amount of bandwidth. In this case, the SDN controller (230) may send information back to the application (225) instructing the application (225) to increase the compression ratio of the end-point device (220-1, 220-2).

In another example, because the SDN controller (230) knows the session information provided by the n-tuple values, the SDN controller (230) may dynamically adjust for failures or other dynamic changes of a number of nodes in the network. For example, where the SDN controller (230) has established a connection between one end-point device (220-1, 220-2) and another end-point device (220-1, 220-2) using a number of switches (205-1, 205-2, 205-3) and one of those switches (205-1, 205-2, 205-3) fails or is taken out of service, the SDN controller (230) may adjust for the failure or topology change and dynamically reroute the session.

In another example, during periods of relatively heavy network load or congestion, the SDN controller (230) may send information back over the API data link (255) to the application (225) instructing the application (225) to switch the call to a lower bitrate codec type or higher compression algorithm for all or some of the currently active sessions. In this case, all or some of the sessions may be dynamically adjusted such that users engaged in active sessions may experience a lower quality definition, but the session will not be dropped entirely due to the heavy network load or congestion. The opposite may also occur; where the SDN controller (230), upon detecting a relatively lower network load, may send this information to the application (225) notifying the application (225) that some or all of the sessions may be switched to a higher bitrate codec type or lower compression algorithm for all or some of the currently active sessions to improve the quality definition and user QoE. In this way, the application (225) does not have to guess as to the current topology of the network or the current network conditions, but instead may be provided this information in real-time from the SDN controller (230).

Even further, the SDN controller (230) may accommodate for instances where a wireless connection in a part of the network may provide a varying amount of bandwidth capacity. In this example, the SDN controller (230) may, in real time, notify the application (225) via the API data link (255) real-time data regarding current bandwidth resources of the network. In one example, as the amount of remaining bandwidth reaches a threshold limit, the SDN controller (230) may instruct the application (225) to switch the session to a lower bitrate codec type or higher compression algorithm for all or some of the sessions currently using bandwidth on the wireless connection or re-route or coordinate a roam of the session to another wireless or wired network connection. This may allow the SDN controller (230) to act as a bandwidth and policy broker such that policies may be dynamically coordinated and changed as bandwidth capacity of the network fluctuates.

The system (400) may also use information gathered by a number of quality metrics engines (405-1, 405-2) associated with the end-point devices (220-1, 220-2) to increase network efficiency and/or the QoE for application sessions. The quality metrics engines (405-1, 405-2) may compile metrics regarding packet loss, latency, and audio quality, among others. These metrics may then be sent to the SDN controller (230) via the application (225) for the SDN controller (230) to dynamically adjust policies if a session's QoE has dropped below a specified threshold. The SDN controller (230) may also correlate the quality metrics between different latency-sensitive sessions provided by different application (225). In this way, the SDN controller (230) may continually be determining whether the network resources are providing the best quality network services to the application (225) and the users of the end-point device (220-1, 220-2).

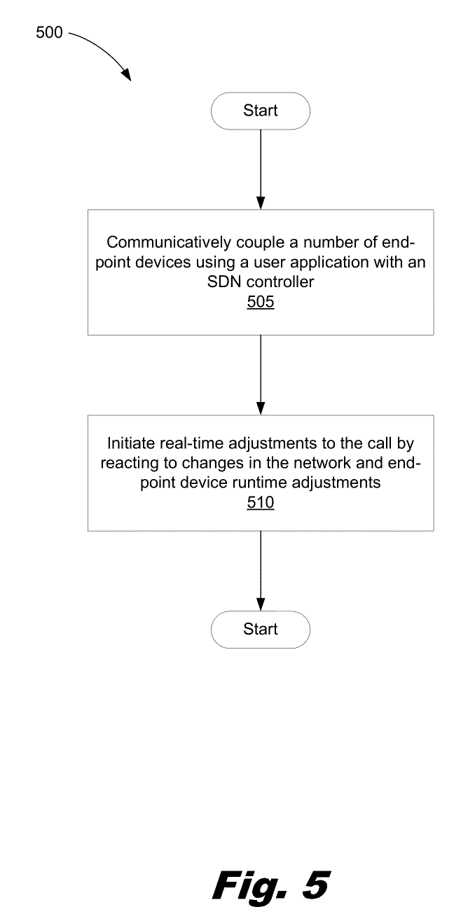

FIG. 5 is a flowchart showing a method (500) of dynamically provisioning a network (400) for network traffic during a call according to one example of principles described herein. The method (500) may begin with the SDN controller (230) communicatively coupling (505) a number of end-point devices (220-1, 220-2) using an application (225). This may be done as described above by one of the end-point device (220-1, 220-2) communicating with the application (225) and the application (225) sending information regarding the end-point device (220-1, 220-2) quality metrics engine (405-1, 405-2) to the SDN controller (230) in order to determine application session QoE on the network. The method may continue with the SDN controller (230) initiating real-time adjustments to the sessions by dynamically reacting to changes in the network topology or network performance characteristics and end-point device (220-1, 220-2) quality metrics engine (405-1, 405-2). These adjustments may continue until the session has been terminated by any end-point device (220-1, 220-2) associated with the session. As described above, the method (500) may further include compiling metrics regarding packet loss, latency, and audio quality, among others at the end-point device (220-1, 220-2) and sending those metrics to the SDN controller (230) for the SDN controller (230) to compile into historical trends to use to improve the user experience and/or more effectively utilize networking resources when creating policies for new application sessions at a future point in time.

In one example, the computer usable program code described above may also further comprise computer usable program code that, when executed by a processor, executes the method as described in FIG. 5. Specifically, the computer readable storage medium may comprise computer usable program code to, when executed by a processor, communicatively couples a number of end-point devices (220-1, 220-2) using an application. The computer usable program code may further comprise computer usable program code to, when executed by a processor, initiates real-time adjustments to the application sessions by dynamically reacting to changes in the network and/or end-point devices quality metrics.

The specification and figures describe a network system and method of provisioning a network for network traffic during a session. The system and method improves latency-sensitive sessions on a network by dynamically adjusting current sessions on the network in reaction to changing network conditions and end-point quality metrics engines. This provides for better user experience and an easier solution for deploying policies throughout the network. Still further, the present system and method optimizes usage of networking resources such that services may be better provided to a user of an end-point device (220-1, 220-2).

The preceding description has been presented to illustrate and describe examples of the principles described. This description is not intended to be exhaustive or to limit these principles to any precise form disclosed. Many modifications and variations are possible in light of the above teaching.

What is claimed is:

1. A network system comprising:
a software-defined network (SDN) controller; and
an application program interface (API) communicatively coupled to an application and the SDN controller;
in which real-time adjustments to sessions are made by the SDN controller by dynamically reacting to changes in the network and a number of end-point devices on the network.

2. The network system of claim 1, in which dynamically reacting to changes to the network and end-point devices comprises rerouting the session through a number of switches in the network, directing the application to switch the session to a lower bitrate, directing the application to switch the session to a higher compression rate, take remedial action to mitigate degradation of quality metrics associated with each end-point device application session, adjusting bandwidth reservations for the type of session, or combinations thereof.

3. The network system of claim 1, in which, in response to receiving the data, the SDN controller provides the API with real-time data describing available bandwidth on the network.

4. The network system of claim 1, in which the SDN controller and the application program interface are communicatively coupled using a trusted connection.

5. The network system of claim 1, in which the SDN controller applies policies to a number of nodes within the network and reserves bandwidth for application sessions to the nodes when the sessions are initiated.

6. The network system of claim 5, in which at least one of the number of nodes is a router, a firewall or other security device, and in which the SDN controller directs the router, firewall or other security device to route data packets associated with the session on a per-call basis such that a port on the router, firewall or security device is not open until the session is initiated.

7. The network system of claim 1, further comprising a quality metrics engine associated with each end-point device, in which, the metrics are periodically provided to and processed by the SDN controller and the SDN controller dynamically adjusts policies based on the metrics received.

8. The network system of claim 1, in which changes to the network comprise changes to the topology of the network, changes to the amount of available bandwidth on the network, due to radio frequency (RF) interference, varying link capacity, changes to the congestion, among other dynamic changes, or combinations thereof.

9. A method of provisioning a network for network traffic during a session, comprising:
communicatively coupling a number of end-point devices using a user application with an SDN controller; and
initiating real-time adjustments to the session by dynamically reacting to changes in the network and end-point device quality metrics.

10. The method of claim 9, in which initiating real-time adjustments to the session by dynamically reacting to changes in the network and/or end-point device quality metrics comprises rerouting the session through a number of switches in the network, coordinating a roaming of the session to another wireless network connection, directing the application to switch the session to a lower bitrate, directing the application to switch the session to a higher compression rate, take remedial action to mitigate degradation of a quality metrics associated with each end-point device application session, adjusting bandwidth reservations for the type of session, or combinations thereof.

11. The method of claim 9, in which, quality metrics from each end-point device are periodically provided to and processed by the SDN controller and the SDN controller dynamically adjusts policies based on the metrics received.

12. The method of claim 9, in which changes to the network comprise changes to the topology of the network due to radio frequency (RF) interference, varying link capacity, changes to the congestion, among other dynamic changes, or combinations thereof.

13. A computer program product for provisioning a network for network traffic during a session, the computer program product comprising:
a computer readable storage medium comprising computer usable program code embodied therewith, the computer usable program code comprising:
computer usable program code to, when executed by a processor, communicatively couple a number of end-point devices using an application with an SDN controller; and
computer usable program code to, when executed by a processor, initiate real-time adjustments to the session by dynamically reacting to changes in the network and end-point device quality metrics.

14. The computer program product of claim 13, further comprising computer usable program code to, when executed by a processor, process metrics from each end-point device by the SDN controller and adjusting future policies based on the historical metrics received by the SDN controller.

15. The computer program product of claim 13, in which changes to the network comprise changes to the topology of the network due to radio frequency (RF) interference, varying link capacity, changes to the congestion, among other dynamic changes, or combinations thereof.
